(19) United States
(12) Patent Application Publication
(10) Pub. No.: US 2005/0125218 A1
(43) Pub. Date: Jun. 9, 2005

(54) Language modelling for mixed language expressions

(76) Inventors: Nitendra Rajput, New Delhi (IN); Ashish Verma, New Delhi (IN)

Correspondence Address: Frederick W. Gibb, III;McGinn & Gibb, PLLC, Suite 304, 2568-A Riva Road, Annapolis, MD, 21401, US

(21) Appl. No.: 10/727,886

(22) Filed: Dec. 4, 2003

(51) Int. Cl. G06F 17/20

(52) U.S. Cl. 704/8; 704/1

(57) ABSTRACT

A language model is constructed for mixed language expressions that have words from more than one natural language. Word equivalence probabilities for pairs of words among the languages are generated and stored. Word equivalence probabilities are used as required to generate a monolingual word history. The monolingual history is used by a monolingual language model to generate a next-word hypothesis. The word equivalence probabilities are also used to compute the next word probabilities in the foreign language.

### FIELD OF THE INVENTION

The present invention relates to language modelling for expressions containing words from different natural languages, termed “mixed language expressions”.

### BACKGROUND

Language models are used in almost all systems in which an understanding of a natural language expression is required. Speech recognition, machine translation, optical character recognition, and text mining are just a few fields in which language models are used. One task of a language model is to predict how likely the occurrence of a given word sequence is for a particular language. The language model provides the probability of a word based upon the history of previous words. An example is the N-gram language model, which predicts the probability of the next word, given N−1 previous words. This model is expressed in Equation [1] below.
P(Wᵢ|Wᵢ₋₁, Wᵢ₋₂, . . . , W_{i-N+1}) [1]

In Equation [1] above, Wᵢ is the word being hypothesized and Wᵢ₋₁, Wᵢ₋₂ . . . W_{i-N+1} are the previous N−1 words in the history. Generally, there are three kinds of language models, namely (i) syntax-based language models, (ii) semantics-based language models, and (iii) models that combine aspects of syntax-based and semantics-based language models.

While syntax-based language model uses the syntax of a given language to predict the probability of a next word, semantics-based language models rely upon the domain context of the previous history of words. A high probability is associated with words from the same domain context.

Finally, both of these approaches can be combined so that a single probability can be determined for the word being hypothesized, using a combination of both the syntax and semantics of the previous words. For example, a weighted average may be taken, or one of the probabilities adopted to the exclusion of the other, based upon a reliability criterion.

The above-mentioned N-gram model is described in R. Kneser and H. Ney, “Improved backing-off for M-gram language modelling,” in Proceedings of IEEE International Conference on Acoustics, Speech and Signal Processing, pages 181-184, volume. 1, May 1995. Existing N-gram models use the history of the previous N−1 words to predict the N-th word in a sequence that would, once available, form a sentence. The N-gram model, or any other similar statistical technique, requires a substantial text corpus in the language for which the language model is to be built. This corpus, however, is typically not available for mixed language expression.

Decision trees, and classification and regression trees can also be used to build a language model. One technique is described in L. R. Bahl, P. F. Brown, P. V. de Souza, and R. L. Mercer, “A tree-based statistical language model for natural language speech recognition”, IEEE Transactions on Acoustics, Speech, Signal Processing, pages 1001-1008, volume 37, July 1989. Such a tree-based approach partitions the history by asking binary questions of the history to reach a leaf node that gives the next word probability.

Context-free grammars (CFG) have also been used to generate sentences. L. G. Miller, and S. E. Levinson, “Syntactic analysis for large vocabulary speech recognition using a context-free covering grammar”, Proceedings of IEEE International Conference on Acoustics, Speech, and Signal Processing, pages 271-274, volume 1, April 1988. Recently, Latent Symantic Analysis has also been used in language modelling to incorporate document semantics in the otherwise syntactical language models. One reference that describes this approach is J. R. Bellegarda, “Speech recognition experiments using multi-span statistical language models”, Proceedings of IEEE International Conference on Acoustics, Speech and Signal Processing, pages 717-720 1999.

The existing techniques described above are not entirely adequate in processing mixed languages expressions, which arise, for example, in spoken language. As an example, English language words and phrases are often embedded in a speaker's native language, due to the dominance of English as an international language. In countries or regions where a large number of different languages are spoken, people borrow words of one language in another language. Creoles of various sorts are a further development of this phenomenon. The syntactical structure of sentences, however, does not change with this mixing of foreign language words.

Renata F I Meuter and Alan Allport, “Bilingual Language Switching in Naming: Asymmetrical Costs of Language Selection”, Journal of Memory and Language 40, pp. 25 to 40, 1999, describe the psychology of how mixed language expressions are generated. The authors studied the language-switch cost across various speakers who speak more than one language. The authors describe the concept of a “weaker language” and a “stronger language” and conclude that the language switch cost is not equal in the two directions.

U.S. Pat. No. 5,913,185, entitled “Determining a natural language shift in a computer document”, and issued Jun. 15, 1999 to Michael John Martino and Robert Charles Paulsen, Jr, describes the concept of language switch probability. Such probabilities are calculated to detect language switch points within a document.

Such a change in language within a sentence is observed to be more frequent in verbal communication rather than in written communication. Documents that use mixed language sentences are relatively infrequent, due to the relative formality of written rather than spoken communication. For example, many Indians use English words embedded in Hindi sentences during conversation. Similarly, Europeans use English words while speaking in their local languages. Such borrowings are relatively common in spoken languages.

Most of the techniques that are used in building language models are statistical in nature. Such statistical techniques require a huge text corpus to train the system. This text corpus must be a representative of the kind of language for which the model is built. No such corpus exists for mixed language expression in the sense used herein. Accordingly, a need exists for an approach to developing a language model for so-called mixed language expressions.

### SUMMARY

The next word within a sentence can be predicted for mixed language expressions. This next word can be of the same language as the text of the previous words, or can be from another language. Such a framework obviates the need to find the “language switch” within a document, as described above. The described techniques can be used in conjunction with existing statistical techniques to build a language model for mixed language documents or text streams.

A database of word equivalence probabilities is used as required by a monolingual language generator. The monolingual language generator uses a mixed-language word history to generate a monolingual word history. The monolingual history is in turn used by a monolingual language model. A resulting next-word hypothesis is used by a next-word language change model, which uses word equivalence probabilities to convert the next word in the monolingual word hypothesis to the next word in the foreign language. An expected mixed-language next word can be provided.

### DESCRIPTION OF DRAWINGS

FIG. 1 is a schematic representation of a framework for building a language model.

FIG. 2 is a schematic representation of a framework for calculating the probability of building a language model.

FIG. 3 is a flow chart that represents steps involved in the techniques described herein.

FIG. 4 is a schematic representation of a computer system suitable for performing the techniques described herein.

### DETAILED DESCRIPTION

A large text corpus is typically required in a given language to build a language model for that language. By extension, existing techniques when applied to mixed language expressions, would require a large text corpus in the mixed language syntax. Even if such a mixed language corpus were to be available, the way in which existing techniques could possibly be used to build a language model for the mixed language is unclear. A different approach, as described herein, is appropriate for mixed languages for which a large corpus is not practicable. Accordingly, use of a mixed language text corpus to train the language model is avoided.

Instead, use is made of a “parallel text corpus” between the base language and the foreign language, whose words and phrases are embedded in the base language. The base language can be thought of as the first or stronger language, and the foreign language can be thought of as the second, other, or weaker language. There can be multiple other languages, though the most usual case is a single other language, and for this reason the terms base language and foreign language are convenient. A monolingual language model is assumed to be available for the base language. Foreign language words are embedded in the base language sentences. As described above, this embedding is such that the grammatical syntax of the base language sentence is substantially unchanged.

From the parallel corpus, word equivalence probabilities are extracted, P_{eq}(W). These word equivalence probabilities P_{eq}(W) predict how likely a word in the foreign language is to be used in place of a given word in the base language. This can be expressed as P_{eq}(W^{f}ᵢ/W^{b}ⱼ), which represents the probability that word W^{f}ᵢ in the foreign language is used in place of W^{b}ⱼ in the base language.

Techniques similar to those used in statistical machine translation systems are used to compute these equivalence probabilities. In the field of machine translation, a sentence-by-sentence parallel corpus is used for the two languages, for which the machine translation system is built. This parallel corpus is used to train the parameters of an alignment model and a lexicon model. The lexicon model represents the word equivalence probabilities for pair of words in between the two languages. A relevant reference is P. F. Brown, J. Cocke, S. Della Pietra, V. Della Pietra, F. Jelinek, R. Mercer, & P. Roossin, “A Statistical Approach to Language Translation”, Proceedings of the 12th International Conference on Computational Linguistics, Budapest, Hungary, 1988.

The resulting probabilities are used with an existing language model to build a language model for the mixed language. In an existing language model, the probability of the next word is predicted based upon the previous history of words, and all the words considered are in the same language, in this context the base language. In the case of a mixed language, the previous history of words can have words of the foreign language and the word to be predicted can also be from the foreign language.

Such a word equivalence probability can be found from studies that are described in Brown et al (referenced above), and also in Dan Melamed, “A Word-to-Word Model of Translational Equivalence”, Proceedings of the Thirty-Fifth Annual Meeting of the Association for Computational Linguistics and Eighth Conference of the European Chapter of the Association for Computational Linguistics, 1997.

A word-to-word equivalence probability is an important feature used in building statistical machine translation systems. Use is made of this probability function to build a language model for mixed-language expressions. This kind of language model can process sentences that have some foreign language words embedded in a base language sentence.

Overview

Consider first the case in which words to be predicted are part of a foreign language, and there are no foreign language words in the word history. The probability of the next foreign language word is calculated by first computing the probability of an equivalent base language word and then multiplying this probability by the equivalence probability that the foreign language word is used instead of the base language word. Finally, this probability is summed over all possible combinations of the base and foreign language words to calculate a final result.

A slightly more complicated scenario involves the previous history of words containing foreign language words. The probability of the next word is computed by replacing all foreign language words in the history by their equivalent words in the base language, and then multiplying this probability by the equivalence probability for the combinations of base and replaced foreign language words.

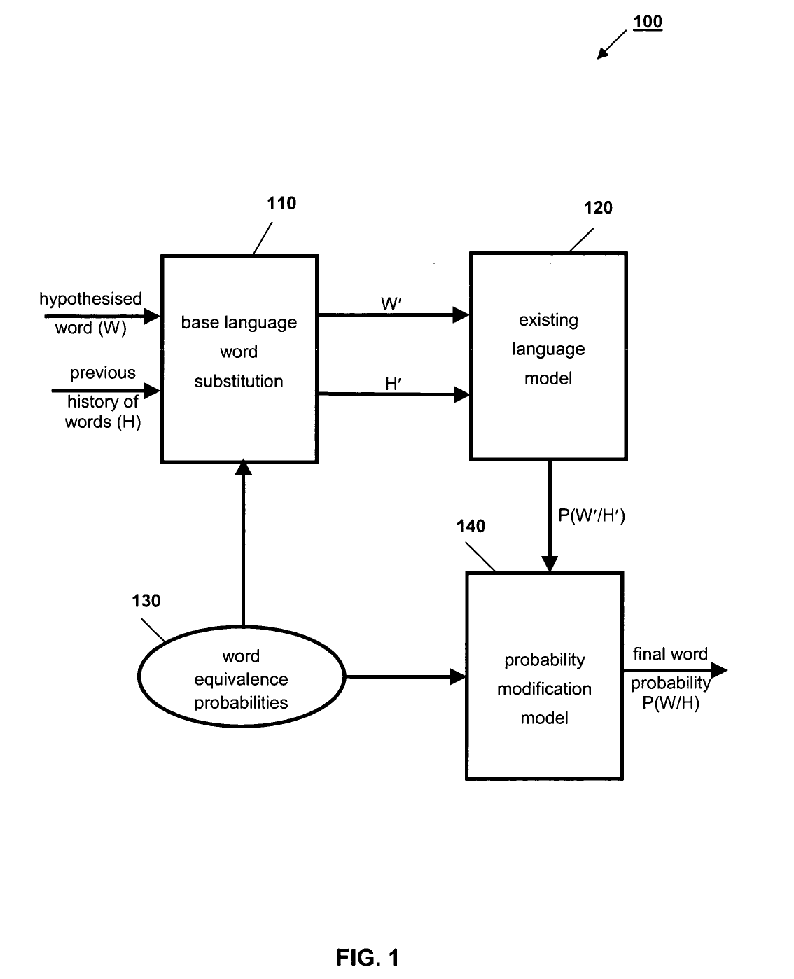

FIG. 1 is a schematic diagram that represents a system architecture 100 for language modelling of mixed language expressions. A hypothesised word (W), and a previous history of words (H) are first provided to a base language word substitution module 110. Consequently, a modified hypothesised word (W′), and a previous history of words (H′) are provided to an existing language model 120 in the base language. Word equivalence probabilities 130 are also generated and stored for later use. The existing language model 120 generates a next word probability based on the modified hypothesised word (W′), and a previous history of words (H′) as P(W′/H′). This information, and the word equivalence probabilities 130 generated previously, are provided to a probability modification model 140 to generate final probabilities P(W/H) for the hypothesised word (W), given the previous history of words (H).

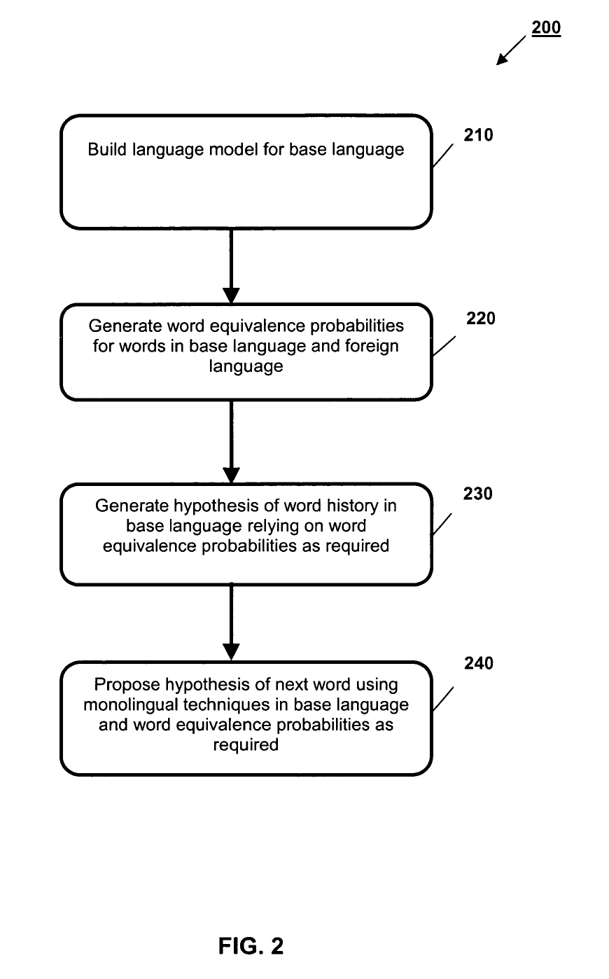

FIG. 2 is a flow chart 200 of steps involved in building a language model that processes mixed language expressions. A first stage is to build a language model for a base language in step 210. Word equivalence probabilities are generated between words in the base language and target words in the foreign language, in step 220. A hypothesis for the word history is generated in the base language in step 230. Word equivalence probabilities are relied upon as required. Finally, a hypothesis is generated for the next word in the base language using monolingual techniques in step 240. Word equivalence probabilities are consulted as required. Particular aspects of this procedure are now described in further detail.

Base Language Model

A language model for the base language is first built in step 210. This step can be performed using standard statistical language model building techniques, since text data for such a language is generally available. For the specific case of Hindi and English, if one expects that the mixed language expression contain more words from Hindi language L₁ (and hence follow its grammatical syntax), a language model is built for L₁. For the same reasons, one builds the language model for English language L₂ if mixed language expressions contain more words in English.

Word Equivalence Probabilities

Word equivalence probabilities are generated for words in the base and foreign languages in step 220. For every word in the base language, there are equivalent words in the foreign language to represent the same or a related meaning. One way of generating such word equivalence probabilities is by statistically determining these word equivalence probabilities using a parallel corpus of the base and foreign languages. Such equivalence can also be learned from a static translation dictionary of the type constructed by linguists. Other techniques described above can also be used for this purpose. Refer to Brown et al, and Melamed, both of which are referenced above.

Generating Base Language Word History Hypothesis

A hypothesis for the word history is generated in the base language in step 230. A language model works on the basis of a given word history. The model attempts to predict the next word in the sequence, given a word sequence history. For the case of a mixed language, if the history has words that are a mix of base and foreign language, the language model built in step 210 not able to handle such a mixed word history. So the hypothesis is generated for the word history in a base language in step 230. This uses the word equivalence probabilities that are calculated in step 220. Based on the word equivalence models, each such hypothesis that is generated in a base language has a “score” associated with the hypothesis. These scores are described in further detail below.

The mixed-language word history is converted to a word history hypothesis, which is represented completely using words of the base language. In case the initial history is itself represented in the base language, there is no need to generate the hypothesis. If, however, the initial history has one or more words drawn from the foreign language and since one wants to represent the initial history in the base language, a hypothesis word history is generated for the base language using the word equivalence probabilities.

Generation of Next Word Hypothesis

Given a history in a base language, one can hypothesise the base language next word in the sequence using standard techniques used in the monolingual language model in step 340. Generating the next word from a mixed-language history is reduced to a problem of generating a next word from a monolingual history.

Generation of Next Word Hypothesis for the Mixed Language Expression

One can hypothesise a word in the base language, given the history in the same language. To hypothesise a word in the foreign language for a history given in base language, use is made of word equivalence. This generates the hypothesis for a next-word in the foreign language, given the next-word in base language. As was the case in step 330, each such hypothesis has a score, which is described in further detail below.

The next word hypothesis is generated in any of the two languages, base or foreign. The history can be either in the base language or in the foreign language, or in a language that contains words that are a mix of the base and foreign language. Hence, a mixed language model is provided. A single foreign language is described for convenience, and more than one foreign language can be used in mixed language expressions.

Implementation Using N-Gram Language Model

A trigram language model is an N-gram language model as described herein, in which N is 3. The merit of word equivalence is represented in terms of a probability function. A trigram language model predicts the probability of the next word given previous two words. This can be represented as in Equation [2] below.
P(W^{s}ᵢ, |W^{s}ᵢ₋₁ W^{s}ᵢ₋₂) [2]

In Equation [2] above, where W^{s}₁ denotes the word W at position i. The superscript s is used to differentiate the language of the word W. So W^{b} represents a word in base language and W^{f} represents a word in a foreign language. In case of a monolingual trigram language model, all the three words belong to the base language.

When only the next word is in foreign language, the probability measure dictated by the trigram language model is modified as follows in Equation [3] below.

$$P ( {W}_{i}^{s} , / {W}_{i - 1}^{s} {W}_{i - 2}^{s} ) where {W}_{i}^{s} ∈ ⊥ {L}^{f} and {W}_{i - 1}^{s} , {W}_{i - 2}^{s} ∈ ⊥ {L}^{b} = {\sum }_{k} {P}_{eq} ( {W}_{i , k}^{f} / {W}_{i , k}^{b} ) P ( {W}_{i , k}^{b} / {W}_{i - 1}^{b} {W}_{i - 2}^{b} ) \qquad [ 3 ]$$

In Equation [3] above ⊥L^{b} and ⊥L^{f} denote the set of words in the base language and the foreign language respectively.

The first term in the right hand side of Equation [3] above denotes the probability of the word W^{f}_{i,k} of the foreign language are used in place of the word W^{b}_{i,k} in the base language. This term is multiplied by the trigram probability of the word W^{b}_{i,k}. This multiplication is summed over all the combination of W^{f}_{i,k} and W^{b}_{i,k}, which gives the desired mixed language probability of W^{f}_{i,k}.

Similarly, when one of the history words is in foreign language, Equation [4] is used to modify the trigram probability.

$${PW}_{i}^{s} , / {W}_{i - 1}^{s} {W}_{i - 2}^{s} = \\ {\sum }_{k} {P}_{eq} ( {W}_{i - 1 , k}^{f} / {W}_{i - 1 , k}^{b} ) P ( {W}_{i - 1}^{b} {W}_{i - 2}^{b} ) \\ when {W}_{i - 1}^{s} ∈ ⊥ {L}^{f} and {W}_{i}^{s} , {W}_{i , 2}^{s} ∈ ⊥ {L}^{b} = \\ {\sum }_{k} {P}_{eq} ( {W}_{i - 2 , k}^{f} / {W}_{i - 2 , k}^{b} ) P ( {W}_{i , k}^{b} / {W}_{i - 1}^{b} {W}_{i - 2}^{b} ) \\ when {W}_{i - 2}^{s} ∈ ⊥ {L}^{f} and {W}_{i}^{s} , {W}_{i - 1}^{s} ∈ ⊥ {L}^{b} \qquad [ 4 ]$$

In Equation [4] above, any word in a language S can be hypothesised using a monolingual language model of the base language and the word equivalence probabilities.

A mixed-language history (represented by the previous two words in case of a trigram language model) can be used to generate the next word in the sequence. The same approach can be extended to more than two languages.

Though the use of a trigram language model is described for implementation purposes, any of the existing statistical language models described above (N-gram in general, LSA, and so on) can also be used for the purpose of calculating the merits of a next-word hypothesis. The next word hypothesis (and previous word history if needed) is converted in the base language using the word equivalence probabilities, and then using the language model of the base language to compute the probability of the next word.

Computer Hardware and Software

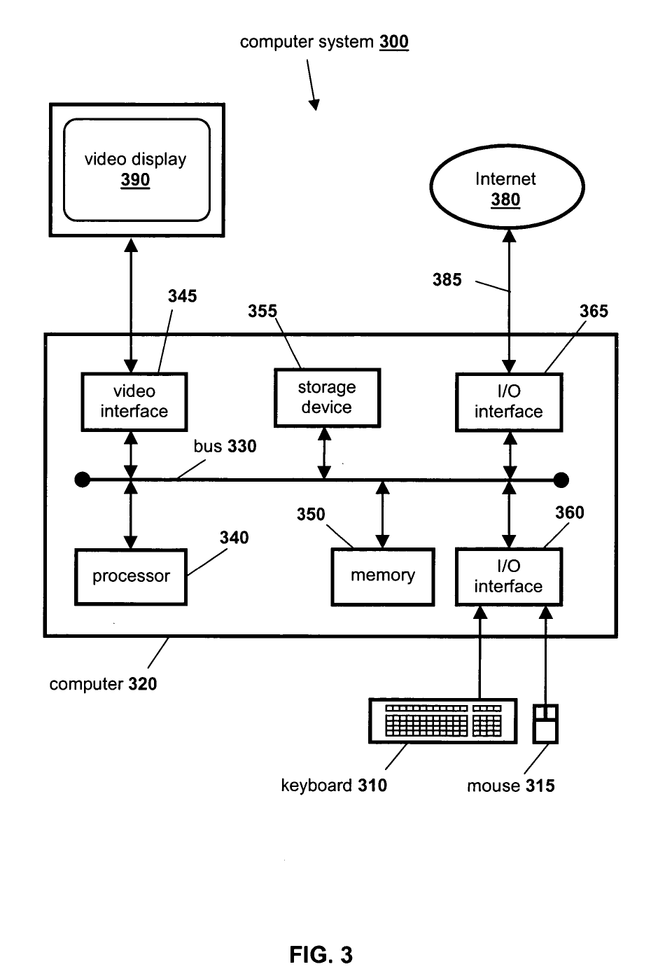

FIG. 3 is a schematic representation of a computer system 400 of a type that can be used to perform language modelling for mixed language expressions as described herein. Computer software executes under a suitable operating system installed on the computer system 300 to assist in performing the described techniques. This computer software is programmed using any suitable computer programming language, and may be thought of as comprising various software code means for achieving particular steps.

The components of the computer system 300 include a computer 320, a keyboard 310 and mouse 315, and a video display 390. The computer 320 includes a processor 340, a memory 350, input/output (I/O) interfaces 360, 365, a video interface 345, and a storage device 355.

The processor 340 is a central processing unit (CPU) that executes the operating system and the computer software executing under the operating system. The memory 350 includes random access memory (RAM) and read-only memory (ROM), and is used under direction of the processor 340.

The video interface 345 is connected to video display 390 and provides video signals for display on the video display 390. User input to operate the computer 320 is provided from the keyboard 310 and mouse 315. The storage device 355 can include a disk drive or any other suitable storage medium.

Each of the components of the computer 320 is connected to an internal bus 330 that includes data, address, and control buses, to allow components of the computer 320 to communicate with each other via the bus 330.

The computer system 300 can be connected to one or more other similar computers via a input/output (I/O) interface 365 using a communication channel 385 to a network, represented as the Internet 380.

The computer software may be recorded on a portable storage medium, in which case, the computer software program is accessed by the computer system 300 from the storage device 355. Alternatively, the computer software can be accessed directly from the Internet 380 by the computer 320. In either case, a user can interact with the computer system 300 using the keyboard 310 and mouse 315 to operate the programmed computer software executing on the computer 320.

Other configurations or types of computer systems can be equally well used to implement the described techniques. The computer system 300 described above is described only as an example of a particular type of system suitable for implementing the described techniques.

### EXAMPLE

An example is described of a Hindi language word embedded in an English language sentence. In this case, the first or base language is English, and the second or foreign language is Hindi. For ease of distinction between words in these two languages, English words are in lower case, while Hindi words are in upper case.

This mixed language sentence is “Delhi becomes very GARM in summer”. In this sentence, “GARM” is a Hindi word embedded in an otherwise English language sentence. Now, during speech recognition of this sentence, to compute the language model probability of the word “GARM”, a mixed language model between Hindi and English would ordinarily be required. As described, such a model is not available, as the text data for this kind of usage is not available.

Instead, the word equivalence probabilities of “GARM” with the equivalent English words (such as “hot”, “warm”, “boiled”, “temperature”, etc.). These equivalent probabilities are estimated by a parallel text corpus between Hindi and English as described.

Continuing this example, the word equivalence probabilities for the given example are presented in Table 1 below.

TABLE 1

P(GARM|hot) = 0.53
P(GARM|warm) = 0.26
P(GARM|boiled) = 0.19

Using the probabilities presented in Table 1, the language model probability of the word “GARM” is obtained (in a trigram framework) according to Equation [5] below.

$$P ( GARM \vert very , becomes ) = P ( GARM \vert hot ) \times P ( hot \vert very , becomes ) + P ( GARM \vert warm ) \times P ( warm \vert very , becomes ) + P ( GARM \vert boiled ) \times P ( boiled \vert very , becomes ) + … \qquad [ 5 ]$$

The probabilities P(hot | very, becomes), P(warm | very, becomes), P(boiled | very, becomes) are obtained from English language model as trigram probabilities, which is a standard technique in the language model field.

Equation [5] shows how word equivalence probabilities are used to compute the language model probabilities for a mixed language sentence that has words from more than one language. These word equivalence probabilities are estimated from a parallel text corpus between two languages which in the form of parallel sentences in the two languages. Examples of a few sentence pairs which can be a part of the parallel corpus are presented in Table 2 below for English and Hindi language

TABLE 1

| | |
|---|---|
| 1. | English: Delhi becomes very hot in summer. |
| | Hindi: DELHI GARMIYON MEIN BAHUT GARM HO JATEE |
| | HAI. |
| 2. | English: Don't forget to take warm clothes when going to the hills. |
| | Hindi: PAHADON MEIN JATE SAMAY GARM KAPDE LE JANA |
| | NAHIN BHULEN. |

Conclusion

Various alterations and modifications can be made to the techniques and arrangements described herein, as would be apparent to one skilled in the relevant art.

1. A method for language modelling of mixed language expressions, said method comprising the steps of:
storing word equivalence probabilities relating to words of a first language and words in at least one other language;
generating a monolingual word history in the first language based upon a mixed language word history and using the stored word equivalence probabilities;
generating monolingual next word hypothesis probabilities in the first language based upon the monolingual word history; and
determining a probability of a next word in a mixed language expression based upon the monolingual next word hypothesis probabilities and the stored word equivalence probabilities.

2. The method as claimed in claim 1, further comprising the step of summing products of word equivalence probabilities with respective monolingual next word hypothesis probabilities.

3. The method as claimed in claim 1, wherein the monolingual next word hypothesis probability is a statistical language model.

4. The method as claimed in claim 1, further comprising the step of converting a mixed language word sequence to a monolingual word sequence using word equivalence probabilities.

5. The method as claimed in claim 1, further comprising the step of determining the word equivalence probabilities based upon a parallel text corpus that has corresponding expressions in the first language and the at least one other language.

6. The method as claimed in claim 1, further comprising the step of determining a probability of a foreign language next word hypothesis given a base language word history.

7. The method as claimed in claim 1, further comprising the step of using a parallel text corpus that has corresponding expressions in the first language and the at least one other language.

8. A computer program product for language modelling of mixed language expressions, the computer program product comprising computer software recorded on a computer-readable medium for performing the steps of:
storing word equivalence probabilities relating to words of a first language and words in at least one other language;
generating a monolingual word history in the first language based upon a mixed language word history and using the stored word equivalence probabilities;
generating monolingual next word hypothesis probabilities in the first language based upon the monolingual word history; and
determining a probability of a next word in a mixed language expression based upon the monolingual next word hypothesis probabilities and the stored word equivalence probabilities.

9. A computer system for language modelling of mixed language expressions, the computer system comprising:
computer software code means for storing word equivalence probabilities relating to words of a first language and words in at least one other language;
computer software code means for generating a monolingual word history in the first language based upon a mixed language word history and using the stored word equivalence probabilities;
computer software code means for generating monolingual next word hypothesis probabilities in the first language based upon the monolingual word history; and
computer software code means for determining a probability of a next word in a mixed language expression based upon the monolingual next word hypothesis probabilities and the stored word equivalence probabilities.

10. The computer program product as claimed in claim 8, further comprising the step of summing products of word equivalence probabilities with respective monolingual next word hypothesis probabilities.

11. The computer program product as claimed in claim 8, wherein the monolingual next word hypothesis probability is a statistical language model.

12. The computer program product as claimed in claim 8, further comprising the step of converting a mixed language word sequence to a monolingual word sequence using word equivalence probabilities.

13. The computer program product as claimed in claim 8, further comprising the step of determining the word equivalence probabilities based upon a parallel text corpus that has corresponding expressions in the first language and the at least one other language.

14. The computer program product as claimed in claim 8, further comprising the step of determining a probability of a foreign language next word hypothesis given a base language word history.

15. The computer program product as claimed in claim 8, further comprising the step of using a parallel text corpus that has corresponding expressions in the first language and the at least one other language.

16. The computer system as claimed in claim 9, further comprising computer software code means for summing products of word equivalence probabilities with respective monolingual next word hypothesis probabilities.

17. The computer system as claimed in claim 9, wherein the monolingual next word hypothesis probability is a statistical language model.

18. The computer system as claimed in claim 9, further comprising computer software code means for converting a mixed language word sequence to a monolingual word sequence using word equivalence probabilities.

19. The computer system as claimed in claim 9, further comprising computer software code means for determining the word equivalence probabilities based upon a parallel text corpus that has corresponding expressions in the first language and the at least one other language.

20. The computer system as claimed in claim 9, further comprising computer software code means for determining a probability of a foreign language next word hypothesis given a base language word history.

21. The computer system as claimed in claim 9, further comprising computer software code means for using a parallel text corpus that has corresponding expressions in the first language and the at least one other language.
